(19) United States
(12) Patent Application Publication
(10) Pub. No.: US 2026/0312711 A1
(43) Pub. Date: Oct. 8, 2026

(54) TIME SYNCHRONIZATION TECHNIQUES

(71) Applicant: Dell Products L.P., Hopkinton, MA (US)

(72) Inventors: Marina Shem Tov, Hod Hasharon (IL); Ishay Zekri, Kfar Yona (IL); Omer Margolin, Tel-Aviv (IL); Ophir Buchman, Raanana (IL)

(73) Assignee: Dell Products L.P., Hopkinton, MA (US)

(21) Appl. No.: 19/098,537

(22) Filed: Apr. 2, 2025

(51) Int. Cl. H04J 3/06; H04L 7/00

(52) U.S. Cl. CPC H04J 3/0667; H04L 7/0016

(57) ABSTRACT

Techniques can include: a first server of a first network sending discover requests to other servers of the first network; receiving, by the first server, discover responses each including a reliability level denoting a reliability of one of the other servers as a time synchronization server; determining, by the first server, a list of reliable servers based, at least in part, on the reliability levels of the discover responses; configuring a time synchronization service of the first server to use the list of reliable servers for time synchronization of a time clock of the first server; performing processing by the first time synchronization service, including: obtaining a time value for each reliable server of the list; and determining a target time based, at least in part, on the time value for each reliable server of the list; and setting the time clock of the first server to the target time.

### BACKGROUND

Systems include different resources used by one or more host processors. The resources and the host processors in the system are interconnected by one or more communication connections, such as network connections. These resources include data storage devices such as those included in data storage systems. The data storage systems are typically coupled to one or more host processors and provide storage services to each host processor. Multiple data storage systems from one or more different vendors can be connected to provide common data storage for the one or more host processors.

A host performs a variety of data processing tasks and operations using the data storage system. For example, a host issues I/O operations, such as data read and write operations, that are subsequently received at a data storage system. The host systems store and retrieve data by issuing the I/O operations to the data storage system containing a plurality of host interface units, disk drives (or more generally storage devices), and disk interface units. The host systems access the storage devices through a plurality of channels provided therewith. The host systems provide data and access control information through the channels to a storage device of the data storage system. Data stored on the storage device is provided from the data storage system to the host systems also through the channels. The host systems do not address the storage devices of the data storage system directly, but rather, access what appears to the host systems as a plurality of files, objects, logical units, logical devices or logical volumes. Thus, the I/O operations issued by the host are directed to a particular storage entity, such as a file or logical device. The logical devices generally include physical storage provisioned from portions of one or more physical drives. Allowing multiple host systems to access the single data storage system allows the host systems to share data stored therein.

### SUMMARY OF THE PRESENT DISCLOSURE

Various embodiments of the techniques herein can include a computer-implemented method, a system and a non-transitory computer readable medium. The system can include one or more processors, and a memory comprising code that, when executed, performs the method. The non-transitory computer readable medium can include code stored thereon that, when executed, performs the method. The method can comprise: a first server of a first network sending discover requests to a server set of other servers of the first network, wherein each of the discover requests queries a corresponding server of the server set regarding whether said corresponding server is a time synchronization server; receiving, by the first server, discover responses from the other servers of the server set, wherein each of the discover responses is sent by a corresponding one of the servers of the server set and wherein said each discover response includes a reliability level denoting a reliability of said corresponding one server as a time synchronization server; determining, by the first server, a list of one or more reliable servers based, at least in part, on the reliability levels of the discover responses; configuring a first time synchronization service of the first server to use the list of one or more reliable servers for time synchronization of a first time clock of the first server; performing first processing by the first time synchronization service, including: obtaining a time value for each reliable server of the list; and determining a target time based, at least in part, on the time value for each reliable server of the list; and setting the first time clock of the first server to the target time.

In at least one embodiment, the first time synchronization service of the first server can set the first time clock. After said setting, processing can include restoring the first time synchronization service of the first server to a first configuration corresponding to a time synchronization configuration of the first time synchronization service prior to said configuring. The first configuration can include an external network time protocol (NTP) server configured as a time synchronization server, wherein the external NTP server can be included in a second network that is external with respect to the first network. The first synchronization service of the first server can be an NTP service. The first server can send the discover requests in response to determining that the external NTP server is unreachable for time synchronization.

In at least one embodiment, processing can include a first community time synchronization (CTS) service of the first server polling the first time synchronization service of the first server for first information regarding time synchronization of the first server. The first information can include: i) second information regarding an existing time synchronization configuration of the first server, and ii) third information regarding a most recent time synchronization of the first time clock of the first server. The second information can indicate whether an external time synchronization server of another network is configured to be used as a time synchronization server and time source for the first server. The third information can include an indication as to whether the first server has completed synchronizing the first time clock with the external time synchronization server of the another network. The third information can include a timestamp denoting when the most recent time synchronization was performed. Processing can include determining, by the first CTS service of the first server, based, at least in part, on the first information, whether to have the first CTS service of the first server initiate processing to synchronize the first time clock of the first server.

Responsive to determining that the first CTS service is to initiate processing to synchronize the first time clock of the first server, the first CTS service of the first server can send the discover requests to the server set.

In at least one embodiment, each other server of the server set can have a corresponding reliability level determined in accordance with a policy. The policy can include a plurality of reliability levels, and for each of the plurality of reliability levels, a set of one or more conditions that evaluate to true in order for a server to be assigned said each reliability level. Determining, by the first server, the list of one or more reliable servers based, at least in part, on the reliability levels of the discover responses can further include: partitioning the discover responses into one or more groups based on the reliability levels of the discover responses, wherein each of the one or more groups denotes a portion of the discover responses having a corresponding one of the plurality of reliability levels; selecting a first group of the one or more groups, wherein the first group has a highest ranked one of the plurality of reliability levels denoting a most reliable level of time synchronization of all of the one or more groups; and determining the list of one or more reliable servers corresponding to the first group of one or more discover responses.

### BRIEF DESCRIPTION OF THE DRAWINGS

Features and advantages of the present disclosure will become more apparent from the following detailed description of exemplary embodiments thereof taken in conjunction with the accompanying drawings in which:

FIGS. 1, 2 and 3 are examples of components that can be included in systems in accordance with the techniques of the present disclosure.

FIG. 4 is an example of services and workflows that can be included in servers, systems or devices in a network in accordance with the techniques of the present disclosure.

FIG. 5 is an example illustrating processing that can be performed in at least one embodiment in accordance with the techniques of the present disclosure.

FIG. 6 is an example of a policy of conditions that can be evaluated to determine whether to perform time synchronization in at least one embodiment in accordance with the techniques of the present disclosure.

FIG. 7 is an example illustrating i) discover and respond workflows in more detail, and ii) a response template that can be used for specifying information returned in a response to a discover request or query in at least one embodiment in accordance with the techniques of the present disclosure.

FIG. 8 is an example illustrating a scoring policy of reliability levels and associated conditions in at least one embodiment in accordance with the techniques of the present disclosure.

### DETAILED DESCRIPTION OF EMBODIMENT(S)

Generally, time synchronization can refer to synchronizing the clocks and associated times of multiple systems or servers. Time synchronization can be critical when operating distributed systems including such multiple systems or servers. Many services, such as network authentication protocols, schedulers, and transactional databases, rely on synchronized clocks to function correctly.

One industry standard that can be used for time synchronization among such multiple systems or servers is the Network Time Protocol (NTP). Although NTP can be used due to its high accuracy, reliability, cost-effectiveness, and scalability, using NTP can have drawbacks. For example, drawbacks of using NTP for time synchronization can include the reliance of NTP on external network connectivity and an external NTP time source of the external network.

Generally, problems can arise using NTP for time synchronization between such multiple systems or servers within one network. For example, there may be no external NTP time source configured for the network. As another example, there may be no external network connectivity or unreliable external network connectivity between i) the external network including the configured external NTP time source and ii) the network of multiple systems or servers attempting time synchronization. In this latter case, the configured external NTP time source of one network can be unreachable or unavailable for use by the systems or servers of another network in connection with time or clock synchronization.

Accordingly, described in the present disclosure are time synchronization techniques that can be used by multiple systems or servers in a network. In at least one embodiment, the techniques of the present disclosure can provide time synchronization among the servers or systems of the network without an external time server and without external network connectivity and communications.

In at least one embodiment, the techniques of the present disclosure provide for time synchronization within the network of servers based, at least in part, on i) the set of servers of the network that respond to a discover request, and ii) reliabilities of corresponding time values of the servers of the set.

In at least one embodiment of the techniques of the present disclosure, a supporting service, also referred to as a Community Time Synchronization (CTS) service, of a server in a network can interact with the NTP service of the server to set the server's local clock based on times returned from a list of reliable servers. In at least one embodiment, the list of reliable servers can be based, at least in part, on i) the set of servers of the network that respond to a discover request, and ii) reliabilities of corresponding time values of the servers of the set. The NTP service of a server can be configured with the list of reliable servers where the NTP service can obtain a corresponding time from each of the configured reliable servers. In at least one embodiment, the NTP service can filter the corresponding times received from the configured reliable servers to dynamically determine a set or quorum of one or more corresponding times to be used as time sources in connection with calculating a target time against which the NTP service can synchronize its local clock time. The foregoing can be performed within the single network of servers without an external NTP server providing a time source for time synchronization.

In at least one embodiment, the techniques of the present disclosure can be utilized as a fallback mechanism in scenarios where i) no external NTP server or time source of an external network is configured, or ii) an external NTP server is configured in an external network but where, at various points in time, the network of servers or systems cannot communicate externally with the external network and/or cannot communicate with the configured external NTP server. In at least one embodiment in such scenarios, the techniques of the present disclosure can provide for time synchronization internally within the network among the network of servers or systems without external network connectivity, without external network communications, and without an external time source or server to synchronize against.

In at least one embodiment, the techniques of the present disclosure can be utilized so that the foregoing servers or systems of the network can internally synchronize time within the network to facilitate communications therebetween. In at least one embodiment, the foregoing internal network time synchronization among the servers or systems of a first network can have a higher priority than time synchronization with other entities which are external with respect to the single first network including the servers or systems.

The foregoing and other aspects of the techniques of the present disclosure are discussed in more detail in the following paragraphs.

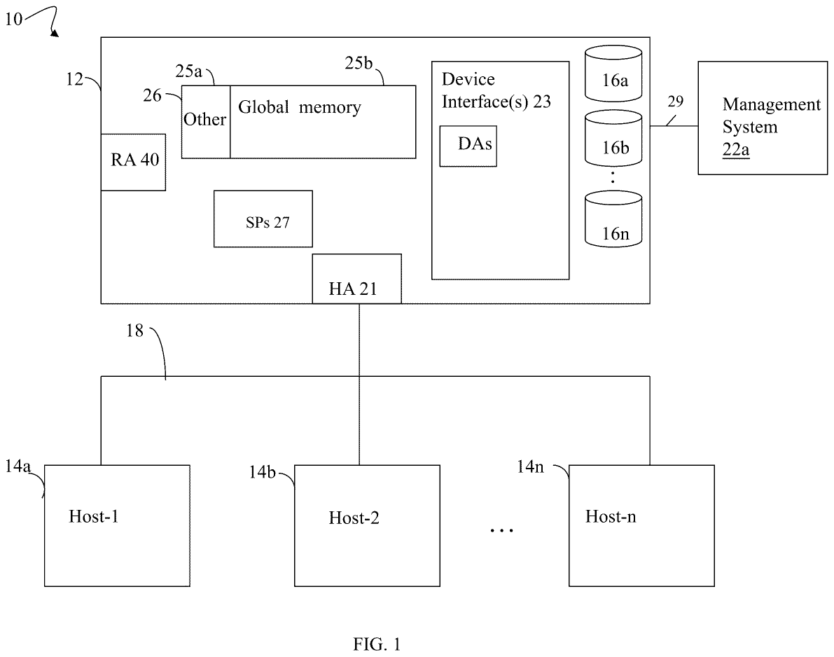

Referring to the FIG. 1, shown is an example of an embodiment of a SAN 10 that is used in connection with performing the techniques described herein. The SAN 10 includes a data storage system 12 connected to the host systems (also sometimes referred to as hosts) 14a-14n through the communication medium 18. In this embodiment of the SAN 10, the n hosts 14a-14n access the data storage system 12, for example, in performing input/output (I/O) operations or data requests. The communication medium 18 can be any one or more of a variety of networks or other type of communication connections as known to those skilled in the art. The communication medium 18 can be a network connection, bus, and/or other type of data link, such as a hardwire or other connections known in the art. For example, the communication medium 18 can be the Internet, an intranet, a network, or other wireless or other hardwired connection(s) by which the host systems 14a-14n access and communicate with the data storage system 12, and also communicate with other components included in the SAN 10.

Each of the host systems 14a-14n and the data storage system 12 included in the SAN 10 are connected to the communication medium 18 by any one of a variety of connections as provided and supported in accordance with the type of communication medium 18. The processors included in the host systems 14a-14n and data storage system 12 can be any one of a variety of proprietary or commercially available single or multi-processor system, such as an Intel-based processor, or other type of commercially available processor able to support traffic in accordance with each particular embodiment and application.

It should be noted that the particular examples of the hardware and software included in the data storage system 12 are described herein in more detail, and can vary with each particular embodiment. Each of the hosts 14a-14n and the data storage system 12 can all be located at the same physical site, or, alternatively, be located in different physical locations. The communication medium 18 used for communication between the host systems 14a-14n and the data storage system 12 of the SAN 10 can use a variety of different communication protocols such as block-based protocols (e.g., SCSI, FC, iSCSI, and/or NVMe (Non-Volatile Memory express)), file system-based protocols (e.g., NFS or network file server), and the like. Some or all of the connections by which the hosts 14a-14n and the data storage system 12 are connected to the communication medium 18 can pass through other communication devices, such as switching equipment, a phone line, a repeater, a multiplexer or even a satellite.

Each of the host systems 14a-14n can perform data operations. In the embodiment of the FIG. 1, any one of the host computers 14a-14n issues a data request to the data storage system 12 to perform a data operation. For example, an application executing on one of the host computers 14a-14n performs a read or write operation resulting in one or more data requests to the data storage system 12.

It should be noted that although the element 12 is illustrated as a single data storage system, such as a single data storage array, the element 12 also represents, for example, multiple data storage arrays alone, or in combination with, other data storage devices, systems, appliances, and/or components having suitable connectivity to the SAN 10 in an embodiment using the techniques herein. It should also be noted that an embodiment can include data storage arrays or other components from one or more vendors. In subsequent examples illustrating the techniques herein, reference is made to a single data storage array by a vendor. However, as will be appreciated by those skilled in the art, the techniques herein are applicable for use with other data storage arrays by other vendors and with other components than as described herein for purposes of example.

In at least one embodiment, the data storage system 12 is a data storage appliance or a data storage array including a plurality of data storage devices (PDs) 16a-16n. The data storage devices 16a-16n include one or more types of data storage devices such as, for example, one or more rotating disk drives and/or one or more non-volatile solid state drives (SSDs). An SSD is a data storage device that uses solid-state memory to store persistent data. SSDs refer to solid state electronics devices as distinguished from electromechanical devices, such as hard drives, having moving parts. Flash devices or flash memory-based SSDs are one type of SSD that contains no moving mechanical parts. In at least one embodiment, the flash devices can be constructed using nonvolatile semiconductor NAND flash memory. The flash devices include, for example, one or more SLC (single level cell) devices, MLC (multi level cell) devices, TLC (triple level cell) devices and/or QLC (quad level cell) devices.

In at least one embodiment, the data storage system or array includes different types of controllers, adapters or directors, such as an HA 21 (host adapter), RA 40 (remote adapter), and/or device interface(s) 23. Each of the adapters (sometimes also known as controllers, directors or interface components) can be implemented using hardware including a processor with a local memory with code stored thereon for execution in connection with performing different operations. The HAs are used to manage communications and data operations between one or more host systems and the global memory (GM). In an embodiment, the HA is a Fibre Channel Adapter (FA) or other adapter which facilitates host communication. The HA 21 can be characterized as a front end component of the data storage system which receives a request from one of the hosts 14a-n. In at least one embodiment, the data storage array or system includes one or more RAs used, for example, to facilitate communications between data storage arrays. The data storage array also includes one or more device interfaces 23 for facilitating data transfers to/from the data storage devices 16a-16n. The data storage device interfaces 23 include device interface modules, for example, one or more disk adapters (DAs) (e.g., disk controllers) for interfacing with the flash drives or other physical storage devices (e.g., PDs 16a-n). The DAs can also be characterized as back end components of the data storage system which interface with the physical data storage devices.

One or more internal logical communication paths exist between the device interfaces 23, the RAs 40, the HAs 21, and the memory 26. An embodiment, for example, uses one or more internal busses and/or communication modules. In at least one embodiment, the global memory portion 25b is used to facilitate data transfers and other communications between the device interfaces, the HAs and/or the RAs in a data storage array. In one embodiment, the device interfaces 23 performs data operations using a system cache included in the global memory 25b, for example, when communicating with other device interfaces and other components of the data storage array. The other portion 25a is that portion of the memory used in connection with other designations that can vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, can also be included in an embodiment.

The host systems 14a-14n provide data and access control information through channels to the storage systems 12, and the storage systems 12 also provide data to the host systems 14a-n also through the channels. The host systems 14a-n do not address the drives or devices 16a-16n of the storage systems directly, but rather access to data is provided to one or more host systems from what the host systems view as a plurality of logical devices, logical volumes (LVs) also referred to herein as logical units (e.g., LUNs). A logical unit (LUN) can be characterized as a disk array or data storage system reference to an amount of storage space that has been formatted and allocated for use to one or more hosts. A logical unit has a logical unit number that is an I/O address for the logical unit. As used herein, a LUN or LUNs refers to the different logical units of storage referenced by such logical unit numbers. The LUNs have storage provisioned from portions of one or more physical disk drives or more generally physical storage devices. For example, one or more LUNs can reside on a single physical disk drive, data of a single LUN can reside on multiple different physical devices, and the like. Data in a single data storage system, such as a single data storage array, can be accessible to multiple hosts allowing the hosts to share the data residing therein. The HAs are used in connection with communications between a data storage array and a host system. The RAs are used in facilitating communications between two data storage arrays. The DAs include one or more types of device interfaced used in connection with facilitating data transfers to/from the associated disk drive(s) and LUN(s) residing thereon. For example, such device interfaces can include a device interface used in connection with facilitating data transfers to/from the associated flash devices and LUN(s) residing thereon. It should be noted that an embodiment can use the same or a different device interface for one or more different types of devices than as described herein.

In an embodiment in accordance with the techniques herein, the data storage system as described can be characterized as having one or more logical mapping layers in which a logical device of the data storage system is exposed to the host whereby the logical device is mapped by such mapping layers of the data storage system to one or more physical devices. Additionally, the host can also have one or more additional mapping layers so that, for example, a host side logical device or volume is mapped to one or more data storage system logical devices as presented to the host.

It should be noted that although examples of the techniques herein are made with respect to a physical data storage system and its physical components (e.g., physical hardware for each HA, DA, HA port and the like), the techniques herein can be performed in a physical data storage system including one or more emulated or virtualized components (e.g., emulated or virtualized ports, emulated or virtualized DAs or HAs), and also a virtualized or emulated data storage system including virtualized or emulated components.

Also shown in the FIG. 1 is a management system 22a used to manage and monitor the data storage system 12. In one embodiment, the management system 22a is a computer system which includes data storage system management software or application that executes in a web browser. A data storage system manager can, for example, view information about a current data storage configuration such as LUNs, storage pools, and the like, on a user interface (UI) in a display device of the management system 22a. Alternatively, and more generally, the management software can execute on any suitable processor in any suitable system. For example, the data storage system management software can execute on a processor of the data storage system 12.

Information regarding the data storage system configuration is stored in any suitable data container, such as a database. The data storage system configuration information stored in the database generally describes the various physical and logical entities in the current data storage system configuration. The data storage system configuration information describes, for example, the LUNs configured in the system, properties and status information of the configured LUNs (e.g., LUN storage capacity, unused or available storage capacity of a LUN, consumed or used capacity of a LUN), configured RAID groups, properties and status information of the configured RAID groups (e.g., the RAID level of a RAID group, the particular PDs that are members of the configured RAID group), the PDs in the system, properties and status information about the PDs in the system, data storage system performance information such as regarding various storage objects and other entities in the system, and the like.

Consistent with other discussion herein, management commands issued over the control or management path include commands that query or read selected portions of the data storage system configuration, such as information regarding the properties or attributes of one or more LUNs. The management commands also include commands that write, update, or modify the data storage system configuration, such as, for example, to create or provision a new LUN (e.g., which result in modifying one or more database tables such as to add information for the new LUN), and the like.

It should be noted that each of the different controllers or adapters, such as each HA, DA, RA, and the like, can be implemented as a hardware component including, for example, one or more processors, one or more forms of memory, and the like. Code can be stored in one or more of the memories of the component for performing processing.

The device interface, such as a DA, performs I/O operations on a physical device or drive 16a-16n. In the following description, data residing on a LUN is accessed by the device interface following a data request in connection with I/O operations. For example, a host issues an I/O operation that is received by the HA 21. The I/O operation identifies a target location from which data is read from, or written to, depending on whether the I/O operation is, respectively, a read or a write operation request. In at least one embodiment using block storage services, the target location of the received I/O operation is expressed in terms of a LUN and logical address or offset location (e.g., LBA or logical block address) on the LUN. Processing is performed on the data storage system to further map the target location of the received I/O operation, expressed in terms of a LUN and logical address or offset location on the LUN, to its corresponding physical storage device (PD) and location on the PD. The DA which services the particular PD performs processing to either read data from, or write data to, the corresponding physical device location for the I/O operation.

It should be noted that an embodiment of a data storage system can include components having different names from that described herein but which perform functions similar to components as described herein. Additionally, components within a single data storage system, and also between data storage systems, can communicate using any suitable technique described herein for exemplary purposes. For example, the element 12 of the FIG. 1 in one embodiment is a data storage system, such as a data storage array, that includes multiple storage processors (SPs). Each of the SPs 27 is a CPU including one or more “cores” or processors and each have their own memory used for communication between the different front end and back end components rather than utilize a global memory accessible to all storage processors. In such embodiments, the memory 26 represents memory of each such storage processor.

Generally, the techniques herein can be used in connection with any suitable storage system, appliance, device, and the like, in which data is stored. For example, an embodiment can implement the techniques herein using a midrange data storage system as well as a higher end or enterprise data storage system.

The data path or I/O path can be characterized as the path or flow of I/O data through a system. For example, the data or I/O path can be the logical flow through hardware and software components or layers in connection with a user, such as an application executing on a host (e.g., more generally, a data storage client) issuing I/O commands (e.g., SCSI-based commands, and/or file-based commands) that read and/or write user data to a data storage system, and also receive a response (possibly including requested data) in connection such I/O commands.

The control path, also sometimes referred to as the management path, can be characterized as the path or flow of data management or control commands through a system. For example, the control or management path is the logical flow through hardware and software components or layers in connection with issuing data storage management command to and/or from a data storage system, and also receiving responses (possibly including requested data) to such control or management commands. For example, with reference to the FIG. 1, the control commands are issued from data storage management software executing on the management system 22a to the data storage system 12. Such commands, for example, establish or modify data services, provision storage, perform user account management, and the like. Consistent with other discussion herein, management commands result in processing that can include reading and/or modifying information in the database storing data storage system configuration information.

The data path and control path define two sets of different logical flow paths. In at least some of the data storage system configurations, at least part of the hardware and network connections used for each of the data path and control path differ. For example, although both control path and data path generally use a network for communications, some of the hardware and software used can differ. For example, with reference to the FIG. 1, a data storage system has a separate physical connection 29 from a management system 22a to the data storage system 12 being managed whereby control commands are issued over such a physical connection 29. However, user I/O commands are never issued over such a physical connection 29 provided solely for purposes of connecting the management system to the data storage system. In any case, the data path and control path each define two separate logical flow paths.

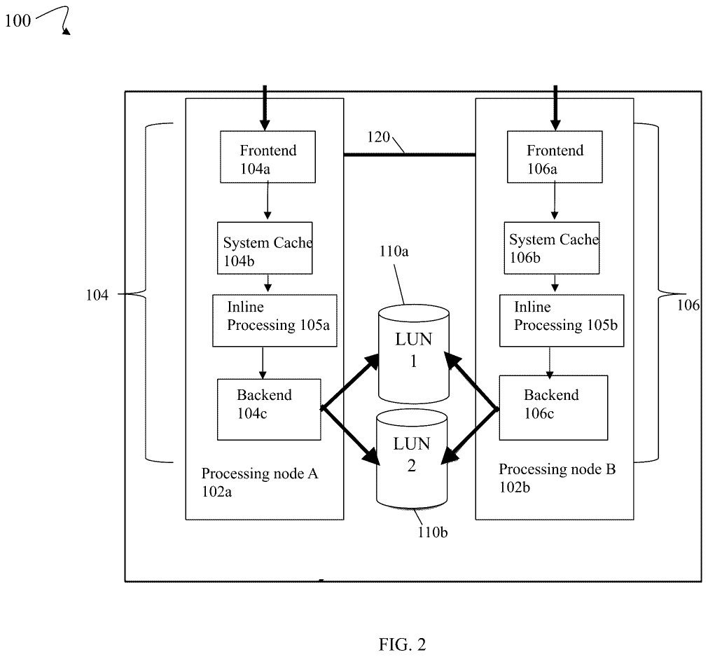

With reference to the FIG. 2, shown is an example 100 illustrating components that can be included in the data path in at least one existing data storage system in accordance with the techniques of the present disclosure. The example 100 includes two processing nodes A 102a and B 102b and the associated software stacks 104, 106 of the data path, where I/O requests can be received by either processing node 102a or 102b. In the example 200, the data path 104 of processing node A 102a includes: the frontend (FE) component 104a (e.g., an FA or front end adapter) that translates the protocol-specific request into a storage system-specific request; a system cache layer 104b where data is temporarily stored; an inline processing layer 105a; and a backend (BE) component 104c that facilitates movement of the data between the system cache and non-volatile physical storage (e.g., back end physical non-volatile storage devices or PDs accessed by BE components such as DAs as described herein). During movement of data in and out of the system cache layer 104b (e.g., such as in connection with read data from, and writing data to, physical storage 110a, 110b), inline processing can be performed by layer 105a. Such inline processing operations of 105a can be optionally performed and can include any one of more data processing operations in connection with data that is flushed from system cache layer 104b to the back-end non-volatile physical storage 110a, 110b, as well as when retrieving data from the back-end non-volatile physical storage 110a, 110b to be stored in the system cache layer 104b. In at least one embodiment, the inline processing can include, for example, performing one or more data reduction operations such as data deduplication or data compression. The inline processing can include performing any suitable or desirable data processing operations as part of the I/O or data path.

In a manner similar to that as described for data path 104, the data path 106 for processing node B 102b has its own FE component 106a, system cache layer 106b, inline processing layer 105b, and BE component 106c that are respectively similar to the components 104a, 104b, 105a and 104c. The elements 110a, 110b denote the non-volatile BE physical storage provisioned from PDs for the LUNs, whereby an I/O can be directed to a location or logical address of a LUN and where data can be read from, or written to, the logical address. The LUNs 110a, 110b are examples of storage objects representing logical storage entities included in an existing data storage system configuration. Since, in this example, writes, or more generally I/Os, directed to the LUNs 110a, 110b can be received for processing by either of the nodes 102a and 102b, the example 100 illustrates what can also be referred to as an active-active configuration.

In connection with a write operation received from a host and processed by the processing node A 102a, the write data can be written to the system cache 104b, marked as write pending (WP) denoting it needs to be written to the physical storage 110a, 110b and, at a later point in time, the write data can be destaged or flushed from the system cache to the physical storage 110a, 110b by the BE component 104c. The write request can be considered complete once the write data has been stored in the system cache whereby an acknowledgement regarding the completion can be returned to the host (e.g., by component the 104a). At various points in time, the WP data stored in the system cache is flushed or written out to the physical storage 110a, 110b.

In connection with the inline processing layer 105a, prior to storing the original data on the physical storage 110a, 110b, one or more data reduction operations can be performed. For example, the inline processing can include performing data compression processing, data deduplication processing, and the like, that can convert the original data (as stored in the system cache prior to inline processing) to a resulting representation or form which is then written to the physical storage 110a, 110b.

In connection with a read operation to read a block of data, a determination is made as to whether the requested read data block is stored in its original form (in system cache 104b or on physical storage 110a, 110b), or whether the requested read data block is stored in a different modified form or representation. If the requested read data block (which is stored in its original form) is in the system cache, the read data block is retrieved from the system cache 104b and returned to the host. Otherwise, if the requested read data block is not in the system cache 104b but is stored on the physical storage 110a, 110b in its original form, the requested data block is read by the BE component 104c from the backend storage 110a, 110b, stored in the system cache and then returned to the host.

If the requested read data block is not stored in its original form, the original form of the read data block is recreated and stored in the system cache in its original form so that it can be returned to the host. Thus, requested read data stored on physical storage 110a, 110b can be stored in a modified form where processing is performed by 105a to restore or convert the modified form of the data to its original data form prior to returning the requested read data to the host.

Also illustrated in FIG. 2 is an internal network interconnect 120 between the nodes 102a, 102b. In at least one embodiment, the interconnect 120 can be used for internode communication between the nodes 102a, 102b.

In connection with at least one embodiment in accordance with the techniques of the present disclosure, each processor or CPU can include its own private dedicated CPU cache (also sometimes referred to as processor cache) that is not shared with other processors. In at least one embodiment, the CPU cache, as in general with cache memory, can be a form of fast memory (relatively faster than main memory which can be a form of RAM). In at least one embodiment, the CPU or processor cache is on the same die or chip as the processor and typically, like cache memory in general, is far more expensive to produce than normal RAM used as main memory. The processor cache can be substantially faster than the system RAM used as main memory. The processor cache can contain information that the processor will be immediately and repeatedly accessing. The faster memory of the CPU cache can for example, run at a refresh rate that's closer to the CPU's clock speed, which minimizes wasted cycles. In at least one embodiment, there can be two or more levels (e.g., L1, L2 and L3) of cache. The CPU or processor cache can include at least an L1 level cache that is the local or private CPU cache dedicated for use only by that particular processor. The two or more levels of cache in a system can also include at least one other level of cache (LLC or lower level cache) that is shared among the different CPUs. The L1 level cache serving as the dedicated CPU cache of a processor can be the closest of all cache levels (e.g., L1-L3) to the processor which stores copies of the data from frequently used main memory locations. Thus, the system cache as described herein can include the CPU cache (e.g., the L1 level cache or dedicated private CPU/processor cache) as well as other cache levels (e.g., the LLC) as described herein. Portions of the LLC can be used, for example, to initially cache write data which is then flushed to the backend physical storage such as BE PDs providing non-volatile storage. For example, in at least one embodiment, a RAM based memory can be one of the caching layers used as to cache the write data that is then flushed to the backend physical storage. When the processor performs processing, such as in connection with the inline processing 105a, 105b as noted above, data can be loaded from the main memory and/or other lower cache levels into its CPU cache.

In at least one embodiment, the data storage system can be configured to include one or more pairs of nodes, where each pair of nodes can be generally as described and represented as the nodes 102a-b in the FIG. 2. For example, a data storage system can be configured to include at least one pair of nodes and at most a maximum number of node pairs, such as for example, a maximum of 4 node pairs. The maximum number of node pairs can vary with embodiment. In at least one embodiment, a base enclosure can include the minimum single pair of nodes and up to a specified maximum number of PDs. In some embodiments, a single base enclosure can be scaled up to have additional BE non-volatile storage using one or more expansion enclosures, where each expansion enclosure can include a number of additional PDs. Further, in some embodiments, multiple base enclosures can be grouped together in a load-balancing cluster to provide up to the maximum number of node pairs. Consistent with other discussion herein, each node can include one or more processors and memory. In at least one embodiment, each node can include two multi-core processors with each processor of the node having a core count of between 8 and 28 cores. In at least one embodiment, the PDs can all be non-volatile SSDs, such as flash-based storage devices and storage class memory (SCM) devices. It should be noted that the two nodes configured as a pair can also sometimes be referred to as peer nodes. For example, the node A 102a is the peer node of the node B 102b, and the node B 102b is the peer node of the node A 102a.

In at least one embodiment, the data storage system can be configured to provide both block and file storage services with a system software stack that includes an operating system running directly on the processors of the nodes of the system.

In at least one embodiment, the data storage system can be configured to provide block-only storage services (e.g., no file storage services). A hypervisor can be installed on each of the nodes to provide a virtualized environment of virtual machines (VMs). The system software stack can execute in the virtualized environment deployed on the hypervisor. The system software stack (sometimes referred to as the software stack or stack) can include an operating system running in the context of a VM of the virtualized environment. Additional software components can be included in the system software stack and can also execute in the context of a VM of the virtualized environment.

In at least one embodiment, each pair of nodes can be configured in an active-active configuration as described elsewhere herein, such as in connection with FIG. 2, where each node of the pair has access to the same PDs providing BE storage for high availability. With the active-active configuration of each pair of nodes, both nodes of the pair process I/O operations or commands and also transfer data to and from the BE PDs attached to the pair. In at least one embodiment, BE PDs attached to one pair of nodes are not shared with other pairs of nodes. A host can access data stored on a BE PD through the node pair associated with or attached to the PD.

In at least one embodiment, each pair of nodes provides a dual node architecture where both nodes of the pair can be generally identical in terms of hardware and software for redundancy and high availability. Consistent with other discussion herein, each node of a pair can perform processing of the different components (e.g., FA, DA, and the like) in the data path or I/O path as well as the control or management path. Thus, in such an embodiment, different components, such as the FA, DA and the like of FIG. 1, can denote logical or functional components implemented by code executing on the one or more processors of each node. Each node of the pair can include its own resources such as its own local (i.e., used only by the node) resources such as local processor(s), local memory, and the like.

In at least one embodiment, the techniques of the present disclosure can be used in a federated environment with respect to a federation of multiple storage systems or servers. In at least one embodiment, the storage systems or servers can be as described in connection with FIG. 2. More generally, the techniques of the present disclosure can be used with any suitable system or device and is not limited to storage systems.

In federated environments in at least one embodiment, each server can synchronize its clock independently. For example, consider 5 servers in a first network. The 5 servers can be configured as a federation of storage systems or servers of a data center. There can be two main modes of operation in data centers, or more generally, federations, where the two modes include a first mode and a second mode. In the first mode, all servers of the first network or federation can synchronize their respective local times or clocks against one or more external NTP servers. For example, the 5 servers of the first network can synchronize their time against one or more external NTP servers not included in the first network. In an alternative second mode, a first server of the first network can synchronize its time against one or more external NTP servers. Subsequently, the remaining servers of the first network can synchronize their respective clocks and times against the first server. Thus in the foregoing first mode, the servers or systems of the federation can directly synchronize their times with the external NTP server or time source, and in the foregoing second mode, the first server or system of the federation can directly synchronize its local time or clock against an external NTP server and the remaining servers or systems of the federation then synchronize against the first server or system.

Desynchronization of clocks of the servers in the first network or federation described above can occur for various reasons. For example, desynchronization can occur due to misconfigurations such as incorrect NTP IP addresses, incorrect firewall rules, and/or missing secondary or failover NTP server configurations (e.g., where the specified secondary NTP server can be used in the event of failure of a primary NTP server). Desynchronization can occur, for example, due to disconnections or connectivity issues such as internet connectivity issues and/or NTP server connectivity issues. Desynchronization can occur, for example, due to security breaches such as NTP server impersonation.

Such desynchronization can result in problems, including inconsistencies and/or failures, such as: i) inconsistent log time stamps of various logs from various systems or servers making it difficult to troubleshoot or triage system problems (e.g., what logged events and/or failures occurred at a same point in time or within a specified window of time across different servers or systems of the same network); ii) TLS (transport layer security) certification validation failures thereby preventing flows from completing; iii) inconsistent timestamps in transactional mechanisms thereby causing a time-based recovery/rollback to lead to data inconsistency; and/or iv) improper metrics aggregation thereby leading to collection of incorrect telemetry data. Such incorrect telemetry data may lead to incorrect or inaccurate information being used, for example, in connection with i) information displayed in a user interface (UI); and/or ii) AI (artificial intelligence) model training.

In at least one embodiment, the techniques of the present disclosure can be utilized to maintain synchronized time across servers in a distributed system when a reliable NTP time source is inaccessible. With respect to the foregoing two modes of operation, the techniques of the disclosure can be used in at least one embodiment as a fallback technique when a configured external NTP time source or server is unreachable by a network, and servers or systems thereof. In at least one embodiment, the techniques of the present disclosure can also be more generally used, for example, if there is no defined or configured NTP time source or server.

Time synchronization between servers and a time server provides benefits including: i) displaying the correct localized timestamp to the end-user; and ii) achieving clock synchronization between servers thereby allowing secure and synchronized communications.

In at least one embodiment, the techniques of the present disclosure define a new novel service, the Community Time Synchronization (CTS) service, that i) discovers available time sources (e.g., devices offering the “NTP Server” service) in the same network; ii) filters reliable time sources; and iii) reconfigures a local NTP client to accordingly use one of the existing time sources within the network as the NTP time source or server. In at least one embodiment, the foregoing can be used, for example, when an existing configured external NTP time source or server (which is external to the network of servers or systems) is unreachable or unavailable for time synchronization.

In at least one embodiment, the techniques of the present disclosure can be based on the following: i) clock synchronization between servers in a data center or the same network is more important than external clock synchronization outside the network or data center; and ii) time synchronization can be performed based, at least on part, on a quorum of one or more select time sources and a pre-defined prioritization or reliability mechanism.

In at least one embodiment, the techniques of the present disclosure can be used as alternative method for time synchronization that can work with or complement NTP such as in response to a misconfiguration or disconnection, where some non-limiting examples of potential misconfigurations and disconnections are noted above. In at least one embodiment, the CTS service can be an extension or plug-in of an NTP service. More generally in at least one embodiment, the CTS service can be used as an extension or plug-in of any suitable time protocol and/or service and is not limited to use with NTP. More generally in at least one embodiment, the CTS service can be used as a standalone service which operates without NTP, or more generally, without any other time protocol or service.

In at least one embodiment, each server, storage system or more generally device can include an NTP service or module instance and a CTS service or module instance.

Examples in the following paragraphs can refer to an embodiment using the CTS service and the NTP service. However, more generally, as noted elsewhere herein, the techniques of the present disclosure can be used in connection with other suitable time sources, protocols, and services and is not limited to use with NTP. More generally as also noted above and elsewhere herein, the techniques can be embodied with CTS as a standalone service which operates without NTP or without any other time protocol or service.

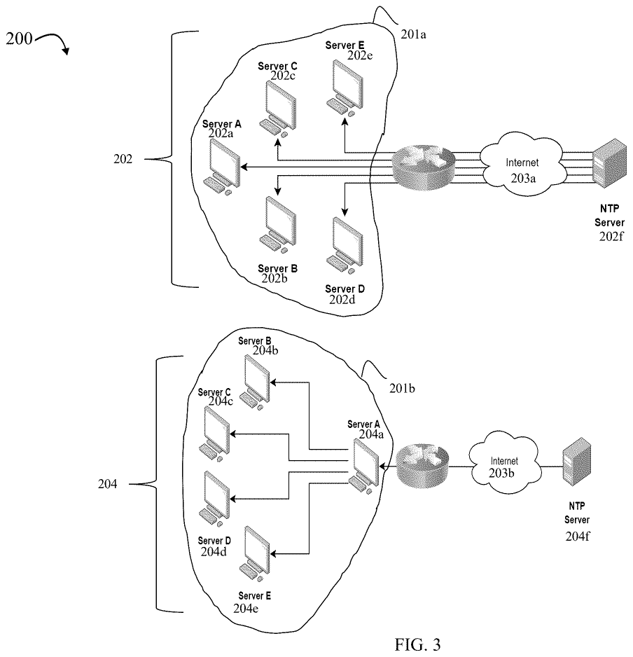

Referring to FIG. 3, shown are examples 202, 204 of components that can be included in embodiments in accordance with the techniques of the present disclosure.

The example 202 includes servers, systems or devices 202a-e of a first network 201a connected by the internet 203a to NTP server 202f in a second network that is external to the first network 201a. The devices 202a-e can have an NTP configuration where the external NTP server 202f is configured as the NTP server providing a time source for time synchronization purposes for the first network and thus for devices 202a-e. In the example 202, the devices 202a-e can operate in accordance with the first mode of operation as discussed above where all the servers, systems or devices 202a-e can directly synchronize their clocks and respective times against the time or clock of the NTP server 202f. In at least one embodiment, the techniques of the present disclosure can be used for time synchronization among the servers, systems or devices 202a-e of the network 201a in response to a misconfiguration and/or disconnection such as with respect to the NTP server 202f. For example, the techniques of the present disclosure described in more detail below can be used by the devices 202a-e to perform time synchronization internally within the network 201a of such devices 202a-e in response to one of the servers or devices 202a-e being unable to communicate with the configured NTP server 202f to perform time synchronization.

The example 204 includes servers, systems or devices 204a-e of network 201b connected by the internet 203b to NTP server 204f in another network that is external to the network 201b. The devices 204a-e can have an NTP configuration and can operate in accordance with the second mode of operation discussed above, where the server 204a synchronizes its local time against the time or clock NTP server 202f, and where all remaining servers 204b-e each synchronize their local respective time and clock against the server 204a. In at least one embodiment, the techniques of the present disclosure can be used for time synchronization among the servers, systems or devices 204a-e in response to a misconfiguration and/or disconnection such as with respect to the NTP server 202f. For example, the techniques of the present disclosure can be used by the devices 204a-e to perform time synchronization internally within the network 201b of such devices 202a-e in response to the server or device 204a being unable to communicate with the configured NTP server 204f to perform time synchronization.

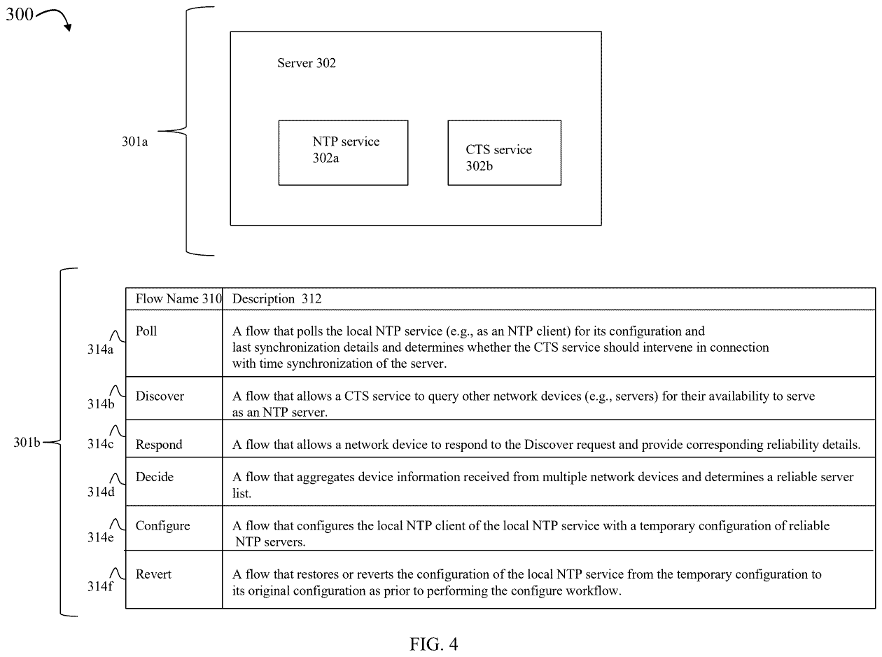

Referring to FIG. 4, shown is an example 300 of components 301a that can be included in each server, system or device of a network in at least one embodiment in accordance with the techniques of the present disclosure. Additionally, the example 300 lists workflows 301b that can be performed by the CTS service of each such server, system or device in at least one embodiment in accordance with the techniques of the present disclosure.

The element 301a illustrates that each server, system or device 302, such as each server 202a-e of network 201a and each server 204a-e of network 201b, can include an NTP service 302a and a CTS service 302b.

In at least one embodiment, the NTP service 302a can perform processing and operate in accordance with a version of NTP to thereby allow the server 302 as a network device to synchronize its local clock or time. In at least one embodiment, the server 302 can act as both a time synchronization client and server. For example in at least one embodiment, the NTP service 302a can perform processing to act as both a time synchronization client (e.g., NTP client) and time synchronization server (NTP server). In at least one embodiment, the server or system 302 can act as a time synchronization server and provide its current clock time in response to queries or requests. In at least one embodiment, the server or system 302 can act as a time synchronization client and can query other devices (e.g., acting as time synchronization sources or time synchronization servers) for their respective clock time.

In at least one embodiment, the CTS service 302b can implement the workflows of the table 301b. The table 301b lists workflow names 310 and corresponding descriptions 312, where each row of the table 301b provides a description (312) for a corresponding one of the workflows (310).

The row 314a indicates that the CTS service of a server can implement the poll workflow that polls the local NTP service (e.g., as an NTP client) of the same server for its configuration and last synchronization details, and then determines whether the CTS service should intervene in connection with time synchronization of the server.

The row 314b indicates that the CTS service can implement the discover workflow that allows the CTS service to query other network devices or servers for their NTP server service availability to function or serve as an NTP server or time source. Put another way, the server issuing the discover request is querying other servers or network devices regarding their respective “NTP server” service availability.

The row 314c indicates that the CTS service can implement the respond workflow that allows a server or network device to respond to discover requests and provide its reliability details. The discover requests can be issued in connection with the discover workflow performed by other CTS services of other respective servers.

The row 314d indicates that the CTS service can implement the decide workflow that aggregates device information received from responses of multiple network devices (e.g., servers) and determines a reliable server list. The foregoing responses can be received by a first CTS service from other CTS services of other servers in response to the first CTS service's requests or queries issued as part of the discover workflow of the first CTS service.

The row 314e indicates that the CTS service of a server can implement the configure workflow that configures the local NTP client (e.g. NTP client portion of the NTP service) of the server with a temporary configuration of reliable NTP servers.

The row 314f indicates that the CTS service of a server can implement the revert workflow that restores or reverts the configuration of the local NTP service from the temporary configuration to its original configuration as prior to performing the configure workflow.

In at least one embodiment, in a polling phase, the CTS service of server A sends a local polling request (as part of the polling workflow) to A's local NTP service to inquire whether the NTP service was able to synchronize its time or clock recently such as within some defined prior time window or other suitable criteria such as discussed in more detail elsewhere herein. If the time synchronization was not recently performed, then the CTS service of server A can issue or broadcast discovery requests (as part of the discover workflow) to other servers in the same network as server A, where such discovery requests can be used to determine what other servers have corresponding times or clocks that server A can synchronize its local time or clock against. CTS services of such other servers can respond (as part of the respond workflow) and provide details of device information including reliability information regarding the responding server's time or clock. The CTS service of server A can aggregate all received responses (as part of the decide workflow) to determine a list of one or more reliable servers which server A can synchronize its local time or clock against. The CTS service of server A can then configure (as part of the configure workflow) the local NTP service with a temporary configuration of the list of one or more reliable servers providing time synchronization sources. After setting the clock on server A such as by an instance of the NTP service based on the temporary configuration, the CTS service of server A can then revert or restore (as part of the revert workflow) the NTP time synchronization configuration of the NTP service of server A as prior to the temporary configuration. The foregoing as can be performed in connection with at least one embodiment is described in more detail below.

In at least one embodiment, the NTP service 302a of each of the servers, devices or systems in a network or federation can operate in accordance with a version of the NTP protocol. For example in at least one embodiment, each such NTP service 302a can operate in accordance with the NTP protocol version 4 as described in RFC-5905, “Network Time Protocol Version 4: Protocol and Algorithms Specification”, ISSN: 2070-1721, June 2010.

In at least one embodiment, given a list of NTP servers providing time sources for time synchronization, the NTP service 302a can allow a network device or server to synchronize its clock by performing processing including: i) Query all NTP servers of the list for their timestamp; ii) Calibrate each timestamp received based, at least in part, on the network lag; iii) Identify reliable timestamps and thus reliable time sources (e.g., such as by eliminating outliers and choosing the best one or more candidate timestamps); iv) Calculate an adjustment delta time to be made to the local clock of the server, system or device including the NTP service 302a, where such adjustment can be made based, at least in part, on one or more of the calibrated reliable timestamps; and v) Adjust the local clock of the server, system or device based on the adjustment determined.

In at least one embodiment, the CTS service 302b of a server, system or device can be used in connection with configuring the particular time synchronization service, such as the NTP service 302a, in accordance with the techniques of the present disclosure described in more detail below. In at least one embodiment, the NTP service 302a of a server or system can be, for example, an operating system program that maintains the system time in synchronization with one or more time servers using NTP, SNTP (Simplified NTP), and/or other suitable time synchronization protocols. In at least one embodiment as noted elsewhere herein, the CTS service relies on all or most network devices to act as both a time synchronization client and a time synchronization server.

In at least one embodiment, the servers or systems of a network, such illustrated in the embodiments of FIG. 3, can have an existing NTP configuration with at least one predefined fixed external NTP server to use for time synchronization. During operation, no configured NTP server may be reachable from the systems or servers of the network, such as described above in connection with FIG. 3. In response in at least one embodiment, the techniques of the present disclosure can be utilized by servers of the network to synchronize their respective times without use of the external NTP server. For example, assume that the network includes 5 servers such as illustrated in configuration 202 of FIG. 3. The server A 202a may determine that it needs to synchronize its local clock and time but may be unable to contact or communicate with the configured external NTP server 202f. As a result in at least one embodiment, the CTS service of server 202a can be used to configure the clock or time of server 202a as maintained by the NTP service of server 202a. In at least one embodiment continuing with this example, the techniques of the present disclosure can include: i) the server 202a determining a set of the remaining servers 202b-e of the same network having reliable timestamps or clock times; ii) the server 202a obtaining respective timestamps or clock times from the set of the remaining servers 202b-e in the same network or federation; and iii) the server 202a synchronizing its local clock time based, at least in part, on the respective timestamps of the set of remaining servers 202b-e. In at least one embodiment, the CTS service of the server 202a can perform processing to generally determine which, if any, of the remaining servers 202b-e can be characterized as having a reliable timestamp or clock time which the server 202a can synchronize its time against. Thus the techniques of the present disclosure can provide a dynamic way of querying the remaining servers 202b-e for their respective clock times or timestamps, where such clock times or timestamps can be used by the server 202a to synchronize its own local time or clock.

In at least one embodiment, the NTP service of the server 202a knows how to communicate with a configured time source such as the external NTP server 202f which can be unreachable or unavailable. In response to the external NTP server 202f being unreachable, i) the CTS service of the server 202a can perform processing in accordance with the techniques of the present disclosure to determine which one or more of the remaining servers 202b-e have reliable clock times or timestamps; ii) the CTS service of the server 202a can reconfigure the local NTP service of the server 202a to use the NTP service of each of one or more remaining servers 202b-e with reliable clock times as time synchronization sources rather than use the external NTP server 202f; iii) the NTP service of the server 202a can query the one or more remaining servers 202b-e for their reliable clock times or timestamps; and iv) the NTP service of the server 202a can set or synchronize the local clock time of the server 202a based, at least in part, on the respective clock times or timestamps of the one or more remaining servers 202b-e determined as reliable with respect to their clock times. Once the local time of the server 202a has been set or synchronized such as by the local NTP service of the server 202a, the CTS service of the server 202a can then restore or revert the time synchronization configuration of the NTP service of the server 202a as it was prior to the above-noted reconfiguration. In this example, the time synchronization configuration of the NTP service of the server 202a can be restored, such as by the CTS service of the server 202a, such that the external NTP server 202f is once again identified as the time synchronization source for the server 202a rather than the one or more remaining servers 202b-e of the reconfiguration.

In this manner in at least one embodiment, the techniques of the present disclosure provide an alternative time synchronization source to the external NTP server 202f when unreachable or unavailable. For example, the NTP server 202f may have been temporarily unreachable or unavailable when server 202a needs to synchronize its time whereby the techniques of the present disclosure can be used. At a later point in time NTP server 202f may be reachable or in communication with the server 202a and the server 202a may once again need to synchronize its time and clock. At this later point in time, the server 202a can synchronize its time and clock against the now reachable NTP server 202f. Thus in at least one embodiment, the techniques of the present disclosure can be dynamically applied and used depending on the availability of a configured time synchronization source such as, for example, the external NTP server 202f.

In at least one embodiment, the CTS service of the server 202a can provide additional functionality that works with the NTP service of the server 202a. In at least one embodiment, the CTS service of the server 202a can poll or query the NTP service of the server 202a to determine if its time is synchronized sufficiently or correctly. The CTS service of the server 202a can i) identify other ones of the remaining servers 202b-e that also include a local instance of the CTS service; and then ii) determine which one or more of such servers 202b-e also have a reliable time clock that can be used by the server 202a for its local time clock synchronization. The CTS service of the server 202a can configure the NTP service of the server 202a with a temporary configuration denoting one or more of the servers 202b-e determined as having a reliable time clock that can be used as a time source in connection with synchronizing the local clock or time of the server 202a. The NTP service of the server 202a can then perform processing, including i) obtaining a timestamp from each of the servers 202b-e of the temporary configuration; and ii) setting the local clock or time of the NTP service of the server 202a based, at least in part, on the timestamps obtained in accordance with the temporary configuration. Once the local time and clock of the server 202a have been set or synchronized, the CTS service of the server 202a can then restore or revert the NTP service of the server 202a from the temporary configuration to its prior configuration, such as where the external NTP server 202f is identified as the time synchronization source for use by the server 202a to synchronize its local clock and time.

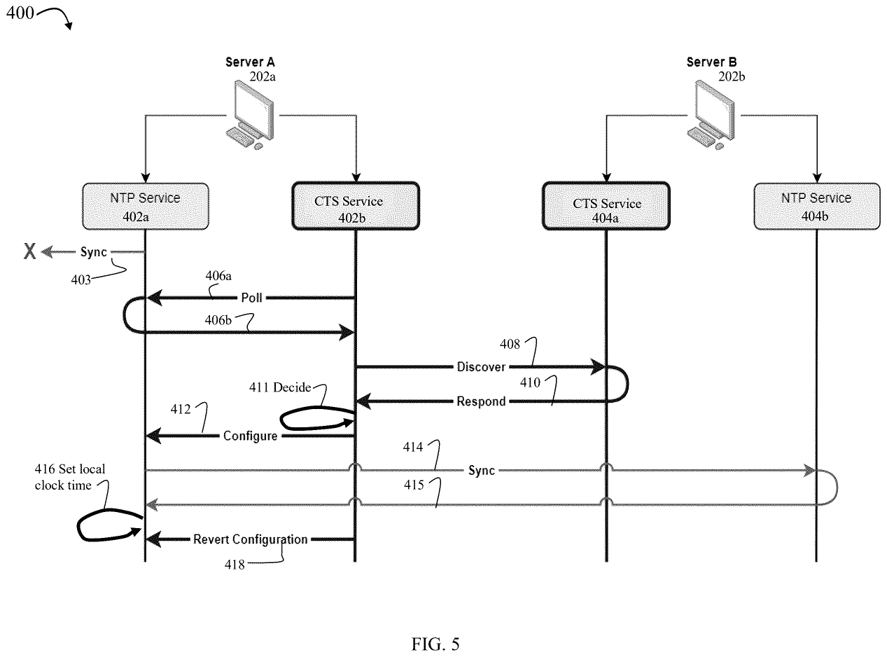

The foregoing is described in more detail below with reference to an example 400 of FIG. 5.

Referring to FIG. 5, shown is the example 400 illustrating processing that can be performed between servers, systems or devices of a network in at least one embodiment in accordance with the techniques of the present disclosure.

The example 400 illustrates processing that can be performed with respect to the server A 202a and the server B 202b of the arrangement 202 of FIG. 3. In this example, the server 202a, as discussed above and also below in more detail, needs to synchronize its time but is unable to communicate with its configured time synchronization source, the external NTP server 202f. The processing flow and components of the example 400 are illustrated only with respect to servers 202a-b for simplicity. More generally, the processing flow and components of the example 400 can be similarly performed between the server 202a and each of the servers 202b-e. Also the example 400 illustrates processing performed when the server 202a needs to synchronize its time. More generally, the same processing can be performed with respect to any one of the servers 202a-e that need to synchronize its time where the one server can then communicate with the remaining ones of the servers.

In the example 400, the server A 202a includes NTP service 402a and CTS service 402b, and the server B 202b includes NTP service 404a and CTS service 404b. More generally with reference to the configuration 202 of FIG. 3, each of the servers or systems of the same network or federation 201a can include their own local respective instances of an NTP service and CTS service.

In a local polling phase, the CTS service 402b of server A 202a can perform the poll workflow and periodically poll 406a the local NTP service 402a (e.g., where the NTP service 402a acts as an NTP client) for information that can be used by the CTS service 402b to determine whether to perform processing in accordance with the techniques of the present disclosure to synchronize the time or clock of the server A 202a. The information requested in the polling request 406a issued by the CTS service 402b and returned 406b by the NTP service 402a can include: i) first information regarding an existing time synchronization configuration (if any); and ii) second information regarding details of the last or most recent time synchronization performed to synchronize time of server A 202a. In at least one embodiment, the first information can, for example, indicate whether an external NTP server, such as the NTP server 202f, is configured for the network 201a including the server A 202a. In at least one embodiment, the second information regarding the last or most recent time synchronization performed for the server 202a can include: information identifying the time source used to synchronize server A 202a's time; information identifying when (e.g., date and time or timestamp) the last or most recent time synchronization of server A 202 was performed; and/or a stratum value and/or other accuracy indicator with respect to the most recent time source used for time synchronization of server A 202a.

In at least one embodiment using NTP, external NTP servers providing times used for time or clock synchronization can be organized in a hierarchy of multiple levels. In NTP, stratum can refer to a hierarchical level indicating a device's distance from the primary reference time source, with lower numbers representing higher accuracy and closer proximity to the primary reference time source. Thus stratum can be used to label or identify the closeness to a central or high quality time server. The stratum can indicate the place of a particular time server in a hierarchy of servers. Put another way, an NTP stratum is a hierarchical system used to classify the accuracy and authority of time sources in a network. Stratum value can be used to provide a measure of the “quality” of a time source, with lower stratum numbers indicating higher accuracy and authority. Each level of this hierarchy can be assigned a number, starting with zero (0) for the reference clock at the top of the hierarchy.

Stratum 0 refers to a reference clock (e.g., atomic clock or a very accurate time source) that is directly set by a national time standard. These clocks are the ultimate authority and the “root” of the time hierarchy.

Stratum 1 devices or time servers have a direct connection with the primary time source of stratum 0, and stratum 1 devices provide that time to clients on stratum 2 via a network connection. These servers receive their time signal directly from the reference clock and are considered highly accurate.

Stratum 2 devices can function like a server by providing time to clients on stratum 3, and Stratum 3 device can provide times to device of stratum 4, and so on. Generally, stratum level N devices can receive times from stratum level N−1 devices (acting as time servers or sources); and stratum level N devices can provide time as a time server or source to clients at stratum level N+1. In at least one embodiment using NTP, there can be a total of 15 synchronized stratum levels where each level introduces another layer of network delay, causing accuracy of provided times to decrease. In at least one embodiment, a time update from a server whose stratum is too high, such as above a specified stratum level, can be rejected and determined as unreliable. In at least one embodiment, low strata time sources can be preferred over higher ones. In general, the lower the stratum number, the more accurate and authoritative the time source. Stratum 1 servers are typically used as reference clocks for organizations or networks, while Stratum 2 and higher servers are used for general-purpose time synchronization.

In at least one embodiment, the CTS service 402b can use the above-noted information returned in the polling response 406b to determine whether to perform further processing for time synchronization for server A 202a using the CTS service 402b. In at least one embodiment a policy can be specified, where the policy includes one or more rules or conditions that can be evaluated based on the information of the polling response 406b in order to determine whether to perform further processing to synchronize the time or clock of server A 202a by CTS 402b in accordance with the techniques of the present disclosure. Put another way in at least one embodiment, the policy can specify conditions that denote when time synchronization, as performed by default using the NTP service 402a and defined time synchronization configuration with the external NTP server 202f, has succeeded or otherwise failed to reliably synchronize server A 202a's clock. Thus the policy can vary with the particular NTP configuration.

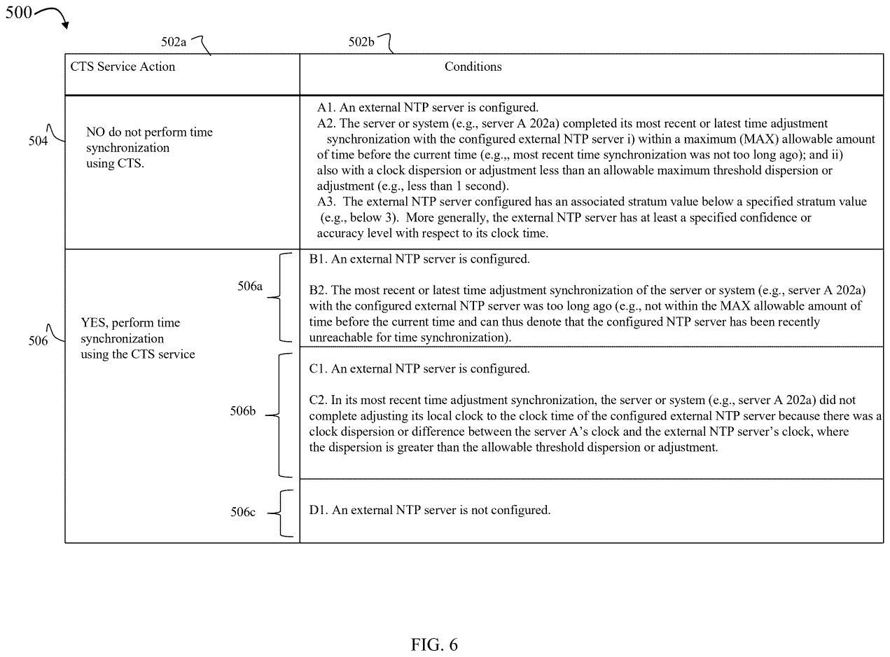

Referring to FIG. 6, shown is an example 500 of a policy that can be used in connection with at least one embodiment in accordance with the techniques of the present disclosure. The information of 500 can be included in a policy that is evaluated by the CTS service 402b in accordance with information returned in the polling response 406 from the NTP service 402a of server A.

The policy 500 can include CTS service actions 502a and corresponding conditions 502b. The row 504 of the policy 500 specifies conditions where a CTS service does not perform time synchronization using the techniques of the present disclosure. In particular the row 504 indicates that the CTS service does not perform time synchronization if the conditions A1, A2 and A3 are all true based, at least in part, on the information of the polling response 406b. In further detail, the row 504 indicates that the CTS service does not perform time synchronization if all of the following conditions A1-A3 are true:
A1. An external NTP server is configured.
A2. The server or system (e.g., server A 202a) completed its most recent or latest time adjustment synchronization with the configured external NTP server i) within a maximum (MAX) allowable amount of time before the current time (e.g., most recent time synchronization was not too long ago); and ii) also with a clock dispersion or adjustment less than an allowable maximum threshold dispersion or adjustment (e.g., less than 1 second).
A3. The external NTP server configured has an associated stratum value below a specified stratum value (e.g., below 3). More generally, the external NTP server can be characterized as providing an accurate clock time with at least a specified confidence or accuracy level with respect to its clock time.

The row 506 of the policy 500 specifies conditions where the CTS service does perform time synchronization using the techniques of the present disclosure. In particular, the row 506 indicates that the CTS service does perform time synchronization if i) conditions B1 and B2 are true; ii) if conditions C1 and C2 are true; or ii) if condition D1 is true. In further detail, element 506a of the row 506 indicates that the CTS service does perform time synchronization if all of the following conditions B1 and B2 are true:
B1. An external NTP server is configured.
B2. The most recent or latest time adjustment synchronization of the server or system (e.g., server A 202a) with the configured external NTP server was too long ago (e.g., not within the MAX allowable amount of time before the current time and can thus denote that the configured external NTP server has been recently unreachable for time synchronization).

The element 506b of the row 506 indicates that the CTS service does perform time synchronization if all of the following conditions C1 and C2 are true:
C1. An external NTP server is configured.
C2. In its most recent time adjustment synchronization, the server or system (e.g., server A 202a) did not complete adjusting its clock to the clock time of the configured external NTP server because there was a clock dispersion or difference between the server's clock and the external NTP server's clock, where the dispersion is greater than the maximum allowable threshold dispersion or adjustment.

In connection with C2 in at least one embodiment, if the dispersion or difference between server A's clock and the target time determined based on a time synchronization source (e.g., the external NTP server) is more than the allowable threshold, server A's clock may not be adjusted in a single increment to the time synchronization source to avoid a single large increment or time change. Rather in at least one embodiment, server A's clock time can be incrementally adjusted in multiple increments at multiple points in time to be synchronized with the target time of the synchronization source. Thus C2 can denote a condition where the foregoing dispersion exceeds the allowable difference and therefore is not implemented as a single increment but rather can be performed with such multiple increments over multiple points in time. C2 can evaluate to true, for example, if the server A 202a has not yet completed adjusting its local clock time to the calculated target time but rather is progressing to complete the foregoing and has adjusted its current local clock time in one or more smaller increments but has not yet reached the target time.

The element 506c of the row 506 indicates that the CTS service does perform time synchronization if the following condition D1 is true:
D1. An external NTP server is not configured.

Thus the elements 506a-c each specify alternative sets of conditions under which the CTS service does perform time synchronization. Put another way, the elements 506a-b can specify alternative sets of conditions denoting unreliable or failed time synchronization for a system or server, such as server A 202a. The element 506c can specify a condition associated with an incomplete or unspecified time synchronization configuration or unspecified NTP time synchronization source. More generally, the policy 500 can include other conditions than as specified in FIG. 5 for illustration purposes.

If the CTS service 402b determines not to perform further processing for time synchronization of server A 202a's clock (e.g., where the conditions of row 504 evaluate to true), the CTS service 402b can wait until the next polling period to repeat the polling 406a, response 406b and then evaluation of the response 406b based on the policy by the NTP service 402a. Otherwise if the CTS service 402b determines to perform further processing for time synchronization of server A 202a's clock (e.g., where the conditions of 506a, 506b or 506c evaluate to true), processing proceeds to the next phase and workflow of the techniques of the present disclosure.

In this example with reference back to FIG. 5, the polling response 406b can include information regarding the last or most recent time synchronization performed by the NTP service 402a using the external NTP server 202f as the time source. Assume in this example that the NTP service 402a has been unable to successfully perform time synchronization (403) for server A 202a based on the defined time synchronization with external NTP server 202f as the time source. For example, the external NTP server 202f may be unavailable or offline, or the external network including the external NTP server 202f may be unreachable such as due to a network connectivity failure. In this scenario, the polling response 406b can indicate that i) the external NTP server 202f is configured as the NTP time synchronization source; and ii) the NTP service 402a's most recent or last time synchronization for server A with the NTP server 202f was too long ago such as, for example, due to the external NTP server 202f being unreachable. For example, the most recent time synchronization of server A with the NTP server 202f may have been 48 hours ago which may exceed a MAX (maximum) allowable time window of 24 hours prior to the present time. In this scenario, the conditions of 506a can evaluate to true thereby resulting in the CTS service 402b taking further action to perform time synchronization for the server A 202a.

In response to the conditions of 506a evaluating to true, the CTS service 402b of server A 202a can perform a discover phase and execute the discover workflow 314b. As part of the discover phase and workflow (408) the CTS service 402b can query other network devices, such as other servers and systems in the same network 201a as the server A 202a, regarding their NTP server service availability. In at least one embodiment, the CTS service 402b of server A 202a can send the discover query 408 to a corresponding CTS service of each of the other servers 202b-e in the network 201a. For example as illustrated in FIG. 5, the CTS service 402b of server A 202a can send the discover request or query 408 to the CTS service 404a of the server B 202b. In reply to the discover request or query 408, the CTS service 404a of the server B 202b can provide a response including information regarding the server B 202b's reliability with respect to its clock time. In at least one embodiment, if any queried server, system or device sent the discover request 408 does not have a CTS service instance and/or does not function as an NTP server providing a time synchronization source, the queried server, system or device may simply not respond to the request 408 and/or return a response indicating that is does not function as an NTP server.

Further details regarding the discover 408 and respond 410 phases and workflows in at least one embodiment are described in more detail below.

As networked devices, such as the servers 202a-e, become smaller, more portable, and more ubiquitous, embodiments can operate with less configured infrastructure. In at least one embodiment, it can be useful to look up or more generally determine what network devices, such as which of the servers or systems 202a-e, can function or serve as NTP servers in the absence of a managed NTP server such as NTP server 202f of a defined NTP configuration or other time synchronization configuration.

In at least one embodiment, discovery processing can be performed to discover NTP servers (e.g., networked devices such as servers or systems 202a-e) on a local link or within the network 201a. The foregoing can be performed, for example, in the absence of an NTP configuration or when a conventional NTP server, such as NTP server 202f, is unavailable. In at least one embodiment, the discovery processing to discover the local NTP servers can be similar in concept to a Multicast DNS Service Discovery (mDNS SD) such as described in RFC-6762, “Multicast DNS”, ISSN: 2070-1721, February 2013.

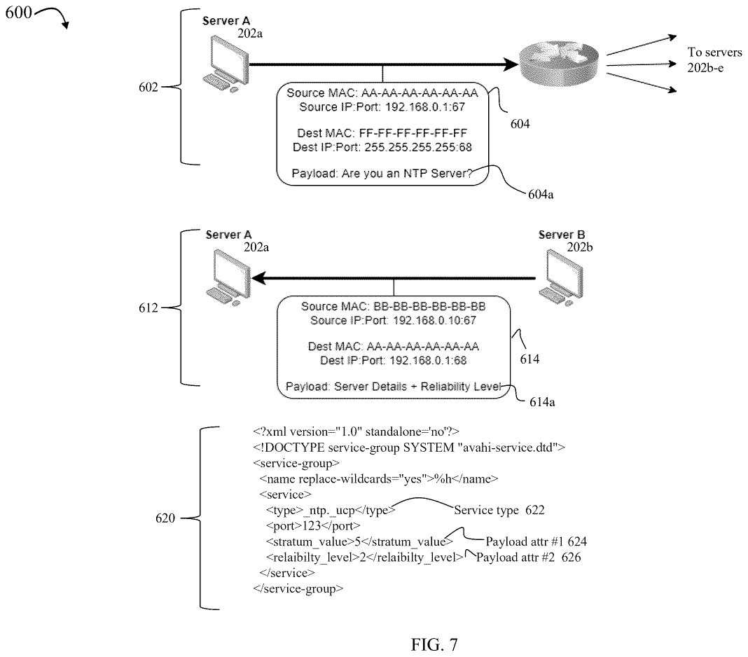

Referring to FIG. 7, shown is an example 600 illustrating aspects of the discover and respond phases and workflows in at least one embodiment in accordance with the techniques of the present disclosure.

During the discover phase 408 in at least one embodiment with reference to 602, the server A 202a sends a query 604 attempting to discover which of the nearby network devices 202b-e provide an “NTP Server” service. In at least one embodiment, the discover queries or requests 604 can be sent as a broadcast or multicast.

The respond phase and workflow take place when a network device, such as server B 202b, hosting an instance of the CTS service, such as the CTS service 404a, receives the query 604 sent in the discover phase. During the respond phase in at least one embodiment with reference to 612, the network device which received the query 604 can send a return response 614 to the requesting device or system. As illustrated in 612, the requesting network device or system can be the server A 202a and the receiving network device or system can be server B 202b which receives the query 604. Responsive to receiving the query 604, the server B 202b can send the response 614 to the server A 202a. In at least one embodiment, the response 614 can include information such as details regarding the server B 202b and a reliability level (614a) of server B with respect to server B's clock time as a time synchronization source. The response 614 can include information used to expose the functionality or capability of the server B 202b to serve as an NTP server. In particular, the response 614 can be returned by the CTS service 404a of server B 202b.

In at least one embodiment, the element 620 provides a configuration template for information to be included in the response 614. The template 620 can be defined to identify the particular fields of data or payload to be returned in the response 614 when responding to the discover request or query 604a, 408 of whether the server B 202b is an NTP server. The template 620 includes i) service type 622 identifying the ability of server B 202b to function as an NTP server and how to respond to an NTP service discover request; ii) payload attribute (attr)1 624 denoting server B's stratum value of 5; and iii) payload attr2 626 denoting server B's reliability level of 2. When a query is sent to server B requesting information regarding server B's NTP server capabilities as denoted by service type 622, the server B can return a response that includes the payload attributes 624 and 626. Thus in at least one embodiment, the response 614 can identify the ability of server B 202b to function as an NTP server by including ii) payload attribute (attr)1 624 denoting server B's stratum value of 5; and ii) payload attr2 626 denoting server B's local time source reliability level of 2.

Consistent with other discussion herein, for purposes of simplicity of illustration, FIG. 7 denotes that a response 614 is returned from only server B 202b to server A 202a. More generally, the remaining servers 202c-e can also similarly return a response with their respective sets of information to the server A 202a.

With reference back to FIG. 5 in at least one embodiment, generally each CTS service of a particular server X can expose server X's NTP server service availability, along with information including server X's respective reliability level, to other servers or devices of the network in a discover response returned (410) in response to a discover request (408).

Further details regarding the reliability level returned in the response (614, 410) in at least one embodiment are described in more detail below.

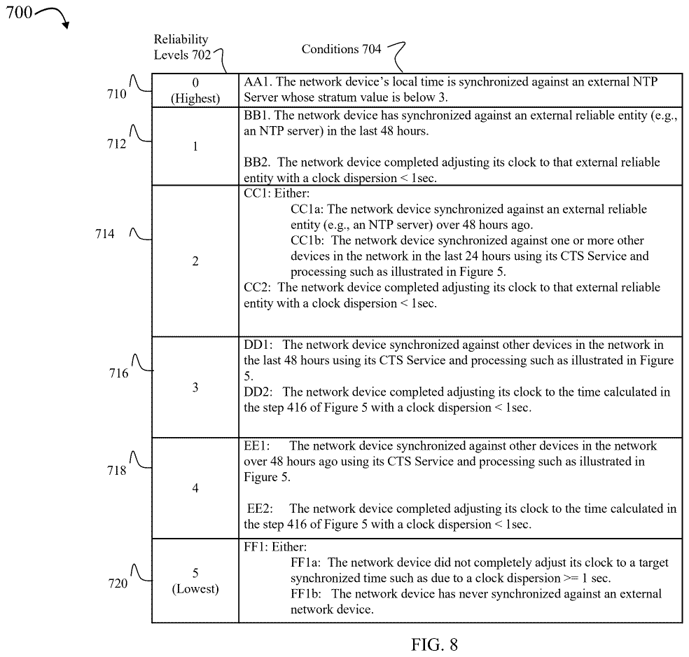

In at least one embodiment, a reliability level of a server, system or other network device can be determined by its CTS service based, at least in part, according to a scoring policy that includes a set of rules such as illustrated in the example 700 of FIG. 8. For example with reference back to FIG. 5 in at least one embodiment, the CTS service 404a can perform processing to determine the reliability level of server B 202b based on the scoring policy of FIG. 8.

FIG. 8 includes a table 700 of reliability levels 702 and corresponding conditions 704 that can be used in at least one embodiment in accordance with the techniques of the present disclosure.

Each row of the table 700 specifies one or more conditions that must evaluate to true in order for a particular network device to be assigned a specified reliability level with respect to the particular network device's clock time. In at least one embodiment, reliability levels 702 can be integer values beginning with 0 such as, for example, 0, 1, 2, 3, 4 and 5. More generally an embodiment can include varying numbers of reliability levels with varying conditions for use with the techniques of the present disclosure. In at least one embodiment, the lower the integer value of the reliability level, the higher or greater the level of reliability of the corresponding system, device or server. Thus in at least one embodiment, reliability levels, ranked from most reliable to least/lowest reliable, can be 0, 1, 2, 3, 4, 5. In at least one embodiment, the reliability level of 0 denotes the most reliable or highest level of reliability, and the reliability level of 5 denotes the least reliable or lowest level of reliability.

The row 710 denotes that the following condition AA1 must be true for a network device, system or server to be assigned reliability level 0:
AA1: The network device's local time is synchronized against an external NTP Server whose stratum value is below 3.

The row 712 denotes that the following conditions BB1 and BB2 must be true for a network device, system or server to be assigned reliability level 1:
BB1: The network device has synchronized against an external reliable entity (e.g., an NTP server) in the last 48 hours.
BB2. The network device completed adjusting or synchronizing its clock to that external reliable entity of BB1 with a clock dispersion<a maximum dispersion, such as, for example, 1 second.

The row 714 denotes that the following conditions CC1 and CC2 must be true for a network device, system or server to be assigned reliability level 2, where CC1 is true if either CC1a or CC1b is true:
CC1a: The network device synchronized against an external reliable entity (e.g., an NTP server) over 48 hours ago.
CC1b: The network device synchronized against one or more other devices in the network in the last 24 hours using its CTS Service and processing described herein such as, for example, illustrated in FIG. 5.
CC2: The network device completed adjusting its clock to that external reliable entity with a clock dispersion<a maximum dispersion, such as, for example, 1 second.

The row 716 denotes that the following conditions DD1 and DD2 must be true for a network device, system or server to be assigned reliability level 3:
DD1: The network device synchronized against other devices in the network in the last 48 hours using its CTS Service and processing such as illustrated in FIG. 5.
DD2: The network device completed adjusting its clock to the time calculated during the clock adjust process in the step 416 of FIG. 5 with a clock dispersion<a maximum dispersion, such as, for example, 1 second.

The row 718 denotes that the following conditions EE1 and EE2 must be true for a network device, system or server to be assigned reliability level 4:
EE1: The network device synchronized against other devices in the network over 48 hours ago using its CTS Service and processing such as illustrated in FIG. 5.
EE2: The network device completed adjusting its clock to the time calculated during the clock adjust process in the step 416 of FIG. 5 with a clock dispersion<a maximum dispersion, such as, for example, 1 second.

The row 720 denotes that either FF1a or FF1b must be true for a network device to be assigned a reliability level of 5:
FF1a: The network device did not completely adjust its clock to the target synchronized time such as due to a clock dispersion >=a maximum dispersion, such as, for example, 1 second.
FF1b: The network device has never synchronized against an external network device.

In at least one embodiment in connection with condition FF1a, if processing as discussed in more detail elsewhere herein determines that the clock of a device needs to be adjusted by 1 second or more in order to be synchronized with a specified or calculated synchronized target clock time (e.g., of an external NTP server or another device in the same network such as 201a as in the step 416), the device's clock time can be adjusted in smaller increments over a defined period of time to avoid a single larger change or time adjustment to the device's clock time. For example, assume that the time difference or dispersion is 10 seconds (e.g., between the device's current time prior to adjustment and the target clock time). Rather than adjust the network device's time by the entire 10 seconds all at once in a single increment or single time adjustment, processing can make 5 smaller 2-second adjustments at 5 corresponding successive points in time to the network device's clock time. In at least one embodiment FF1a can evaluate to true when the network device adjusts its time by one of the smaller 2 second adjustments and where the resulting adjusted clock time of the network device is not yet synchronized to the final desired target clock time.

It should be noted that although particular time thresholds, such as 24 hours and 48 hours, are referenced in connection with FIG. 8 and other discussions herein, more generally, any suitable time thresholds can be utilized and can vary with embodiment.

Returning again to FIG. 5, when a network device, system or server, such as server A 202a, sends a discover request 408 across the network, the sending device such as server A 202a can wait a defined period of time, such as 3 seconds or any other suitable amount of time. During the foregoing defined period of time, the server A 202a can collect respond packets or responses (410) from other servers 202b-e of the network 201a.

Once the defined period of time has elapsed, a decide phase 411 can be initiated and performed by the CTS service 402b of the server A 202a.

During the defined period of time, if no responses (410) are received by the requesting server A 202a from any other servers 202b-e, processing in connection with the techniques of the present disclosure can stop where no time synchronization is performed for the server A 202a by the CTS service 402b.

As an alternative to the foregoing, during the defined period of time, one or more responses (410) can be respectively received from one or more of the servers 202b-e. In this scenario, processing of the decide phase 411 can be performed by the CTS service 402b of the requesting server A 202a using the one or more received responses (410). In at least one embodiment, the decide phase 411 processing performed by the CTS service 402b of the server A 202a can include performing the step S1, where S1 includes segmenting or partitioning the received responses 410 into groups based on their corresponding reliability levels. For example, assume that there are 10 servers in the network 201a rather than just 5 servers illustrated. In this case, the server A 202 sends the discover query 408 to the 10 servers and receives 10 discover responses 410 from the respective 10 servers. In the step S1, the 10 discover responses can be partitioned into 3 groups where each group corresponds to a single one of the possible reliability levels 0-5. In this example, a first group GP1 can be formed of all responses specifying reliability level 1; a second group GP2 can be formed of all responses specifying reliability level 2; and a third group GP3 can be formed of all responses specifying reliability level 4. The first group GP1 of reliability level 1 can have 4 responses, the second group GP2 of reliability level 2 can have 2 responses, and the third group GP3 of reliability level 4 can have 4 responses.

Following the step S1, a step S2 can be performed. The step S2 can include selecting the particular group of responses that are most reliable such as having the highest ranked reliability level (e.g., most reliable) of all the groups of responses. Continuing with the foregoing example of 10 responses with the above-noted 3 groups GPs 1-3, the first group GP1 of reliability level 1 is the highest ranked or most reliable of all 3 groups GPs 1-3 such as, for example, as discussed in connection with FIG. 8 in at least one embodiment. In this example, the step S2 can include selecting the first group GP1 of 4 responses of reliability level 1 as the most reliable of all 3 groups GPs1-3 of responses. In this example, assume that the first group GP1 of 4 responses of reliability level 1 are returned respectively by the other servers 202b-e.

Following the step S2, a step S3 can be performed. The step S3 can include determining a list of reliable servers based, at least in part, on the selected group denoting the highest ranked or most reliable servers. Continuing with the foregoing example where GP1 is selected in the step S2, the list of reliable servers can be the servers 202b-e each of which sent a respective one of the 4 discover responses including a reliability level of 1, where such 4 discover responses form the first group GP1 of reliability level 1.

In at least one embodiment, the foregoing steps S1, S2 and S3 can be included in the decide phase 411 and associated processing as performed by the CTS service 402b of the server A 202a.

With reference back to FIG. 5 and following the decide phase 411, the configure phase processing (412) can be performed. In at least one embodiment, the configuration phase processing 412 can include the CTS service 402b configuring the NTP service 402a with a temporary configuration specifying the list of reliable servers (as determined in the decide phase 411). In this manner, the NTP service 402a can perform processing to synchronize the local clock time of the server A 202a based, at least in part, on the temporary configuration of the reliable servers 202b-e.

In at least one embodiment, the NTP service 402a can issue a sync (synchronization) request 414 to each of the reliable servers 202b-e of the temporary configuration, where each such server 202b-e can accordingly return a response 415. In at least one embodiment, the sync request 414 be a request for the receiving reliable server to return a timestamp denoting the reliable server's current clock time.

In at least one embodiment, the NTP server 402a can perform processing to set the local time clock of the server A 202 as denoted by 416. In at least one embodiment, processing of 416 can include determining a calculated target time based, at least in part, on the various clock times returned in the sync responses 415 from the reliable servers. In at least one embodiment, the target time can denote the updated synchronized time for the local clock time of the server A 202. The processing of 416 can include then setting the local clock time of the server A 202 to be the target time.

In at least one embodiment, the NTP service 402a can generally use any suitable algorithm or technique to i) filter the clock times returned in the sync responses 415 from the reliable servers and ii) determine the target time based, at least in part, on the clock times returned in the sync responses 415 from the corresponding reliable servers, such as servers 202b-e in the foregoing example. In at least one embodiment, the NTP server 402a can determine the target time by discarding any one or more outlier clock times of the sync responses and then using the remaining clock times to determine the target time. For example, a clock time can be characterized as an outlier if it varies from the average of all returned clock times by more than an allowable amount, such as more than a number of standard deviations from the average of all returned clock times. To further illustrate, assume there are the following 4 clock times: 9:00 am, 9:01 am, 9:02 am and 9″5 am. The clock time 9:15 am may be determined as an outlier because of its large difference or variation from the remaining 3 clock times. In this case, the target time can be calculated based on the remaining 3 clock times of 9:00 am, 9:01 am, and 9:02 am. For example, the target time can be determined as 9:01 am based on an average of the remaining 3 clock times.

In at least one embodiment in this example, the list of reliable servers can be dynamic in that they can vary with i) the particular servers 202b-e that respond 410 to the discover request 408; ii) the particular capabilities or abilities of each such server to function as an NTP server or more generally provide a time synchronization source; and/or iii) the reliability levels of the particular servers 202b-e that respond 410 to the discover request 408. The particular one or more servers forming the reliable server list can denote a dynamic set of time synchronization sources or servers such as, for example, NTP time synchronization sources.

In at least one embodiment, the target time determined in connection with the step 416 based on the clock times of the sync responses 415 can be based on a selected quorum of one or more of the sync responses 415 of the configured reliable servers. As discussed above and generally elsewhere herein, the target time calculated in the step 416 can be characterized as a quorum-based decision based on a selected quorum of one or more of the list of configured reliable servers. In connection with the foregoing example to further illustrate, assume that the NTP service 402a is configured by the step 412 to have the 4 servers 202b-e as the reliable server list. Also assume as discussed above that the sync responses 415 from the 4 servers 202b-e respectively return the following 4 clock times: 9:00 am, 9:01 am, 9:02 am, and 9:15 am. The clock time 9:15 am, as returned by server 202e's sync response 415, may be determined as an outlier because of its large difference or variation from the remaining 3 clock times. In this example, the 3 servers 202b-d can form the quorum having corresponding time synchronization sources used to determine the calculated target time.

Thus in at least one embodiment, the quorum can generally denote the selected set of one or more reliable servers and corresponding clock times returned in the sync responses 415, where the clock times of the selected set forming the quorum can be used as time sources in calculating the target time in the step 416 to which the local clock of server A 202a can be set or synchronized with. Generally in at least one embodiment, the quorum can based, at least in part, on the configured list of reliable servers and their corresponding times returned in the sync responses 415. In at least one embodiment, the quorum can vary with the particular algorithm or technique implemented by the time synchronization service, such as the NTP server 402a, in connection with filtering the times of the sync responses 415 and calculating the target time. In at least one embodiment, the quorum can generally be one or more of the configured reliable servers and respective one or more times returned in corresponding one or more sync responses 415. In at least one embodiment, for example, the quorum can be all configured reliable servers and corresponding time if such corresponding times are not determined as outliers. Thus the quorum can be as few as a single one of the configured reliable servers and a single corresponding time, to at most all configured reliable servers and corresponding times of the sync responses 415. The particular reliable servers and times selected as the quorum can vary with embodiment.

In at least one embodiment, the quorum can be based on filtering the synchronization times of the sync responses 415 returned from the reliable servers based, at least in part, on one or more filtering criteria to determine a set of one or more consistent times to be used for calculating the target time used to synchronize the local clock time of server A 202a. In at least one embodiment, the filtering criteria can be based, at least in part, on a statistical analysis, variation and/or deviation of the returned times of the sync responses 415 from an average of such times.

Consistent with other discussion in at least one embodiment, the local time clock of the server A 202a can be set to the target time calculated in the step 416 if, for example, the calculated difference between the target time and the current clock time of server A 202a is not more than a maximum allowable time difference or dispersion. In at least one embodiment, if the calculated difference exceeds the maximum allowable time difference or dispersion, the clock time of server A 202a can be adjusted in multiple adjustments or increments at multiple periods of time to avoid making a single larger time adjustment equal to the calculated difference.

In at least one embodiment, the NTP service 402a can utilize the clock filter algorithm as specified in Section 10 of the RFC-5905 noted elsewhere herein. More generally, the NTP service 402a or alternative time synchronization service instance of the server A 202a can use any suitable technique to further filter the times included in the responses 415 from the temporary configuration of reliable servers.

After setting the local clock time 416, the CTS service 402b can perform the processing of 418 to revert or restore the local NTP client portion of the NTP service 402a to its original configuration of one or more time synchronization servers as prior performing step 412. For example, prior to step 412 in at least one embodiment, the NTP service 402a of the server A 202a may have had a corresponding first configuration which specified the NTP server 202f as the time synchronization source or server. After performing the step 416, processing of step 418 can reconfigure or restore the current configuration of the NTP service 402a to be the foregoing first configuration with the NTP server 202f as the time synchronization source or server.

Described above are techniques of the present disclosure that can be used in at least one embodiment for configuring a server's NTP service, as a local NTP client, with a dynamic list of reliable servers as time sources that can be used for time synchronization of the local clock time of the server's NTP service. The dynamic list of reliable servers can be based, at least in part, on one or more factors, where the one or more factors can include: i) the particular servers that respond (410) to the discover request or query (408); and/or ii) for each of the servers that responds in 410, a reliability level associated with the server as a time synchronization source. The reliability level can denote a level of reliability with respect to a time provided by the corresponding server as a time synchronization source used in synchronizing a local time of another server than sent the discovery query or request (408). In at least one embodiment, the techniques of the present disclosure can be used to synchronize the time of a server, system or device of a network that can be disconnected from an external NTP server of another network.

The techniques herein can be performed by any suitable hardware and/or software. For example, techniques herein can be performed by executing code which is stored on any one or more different forms of computer-readable media, where the code can be executed by one or more processors, for example, such as processors of a computer or other system, an ASIC (application specific integrated circuit), and the like. Computer-readable media can include different forms of volatile (e.g., RAM) and non-volatile (e.g., ROM, flash memory, magnetic or optical disks, or tape) storage which can be removable or non-removable.

While the techniques of the present disclosure have been presented in connection with embodiments shown and described in detail herein, their modifications and improvements thereon will become readily apparent to those skilled in the art. Accordingly, the spirit and scope of the techniques of the present disclosure should be limited only by the following claims.

What is claimed is:

1. A computer-implemented method comprising:
a first server of a first network sending discover requests to a server set of other servers of the first network, wherein each of the discover requests queries a corresponding server of the server set regarding whether said corresponding server is a time synchronization server;
receiving, by the first server, discover responses from the other servers of the server set, wherein each of the discover responses is sent by a corresponding one of the servers of the server set and wherein said each discover response includes a reliability level denoting a reliability of said corresponding one server as a time synchronization server;
determining, by the first server, a list of one or more reliable servers based, at least in part, on the reliability levels of the discover responses;
configuring a first time synchronization service of the first server to use the list of one or more reliable servers for time synchronization of a first time clock of the first server;
performing first processing by the first time synchronization service, including:
obtaining a time value for each reliable server of the list; and
determining a target time based, at least in part, on the time value for each reliable server of the list; and
setting the first time clock of the first server to the target time.

2. The computer-implemented method of claim 1, wherein the first time synchronization service of the first server performs said setting the first time clock.

3. The computer-implemented method of claim 1, further comprising:
after said setting, restoring the first time synchronization service of the first server to a first configuration corresponding to a time synchronization configuration of the first time synchronization service prior to said configuring.

4. The computer-implemented method of claim 3, wherein the first configuration includes an external network time protocol (NTP) server configured as a time synchronization server, wherein the external NTP server is included in a second network that is external with respect to the first network.

5. The computer-implemented method of claim 4, wherein the first synchronization service of the first server is an NTP service.

6. The computer-implemented method of claim 4, wherein the first server sends the discover requests in response to determining that the external NTP server is unreachable for time synchronization.

7. The computer-implemented method of claim 4, further comprising:
a first community time synchronization (CTS) service of the first server polling the first time synchronization service of the first server for first information regarding time synchronization of the first server.

8. The computer-implemented method of claim 7, wherein the first information includes i) second information regarding an existing time synchronization configuration of the first server, and ii) third information regarding a most recent time synchronization of the first time clock of the first server.

9. The computer-implemented method of claim 8, wherein the second information indicates whether an external time synchronization server of another network is configured to be used as a time synchronization server and time source for the first server.

10. The computer-implemented method of claim 8, wherein the third information includes an indication as to whether the first server has completed synchronizing the first time clock with the external time synchronization server of the another network.

11. The computer-implemented method of claim 8, wherein the third information includes a timestamp denoting when the most recent time synchronization was performed.

12. The computer-implemented method of claim 7, further comprising:
determining, by the first CTS service of the first server, based, at least in part, on the first information, whether to have the first CTS service of the first server initiate processing to synchronize the first time clock of the first server.

13. The computer-implemented method of claim 12, further comprising:
responsive to determining that the first CTS service is to initiate processing to synchronize the first time clock of the first server, the first CTS service of the first server performing said sending that sends the discover requests to the server set.

14. The computer-implemented method of claim 1, wherein each other server of the server set has a corresponding reliability level determined in accordance with a policy.

15. The computer-implemented method of claim 14, wherein the policy includes a plurality of reliability levels, and for each of the plurality of reliability levels, a set of one or more conditions that evaluate to true in order for a server to be assigned said each reliability level.

16. The computer-implemented method of claim 15, wherein said determining, by the first server, the list of one or more reliable servers based, at least in part, on the reliability levels of the discover responses further includes:
partitioning the discover responses into one or more groups based on the reliability levels of the discover responses, wherein each of the one or more groups denotes a portion of the discover responses having a corresponding one of the plurality of reliability levels;
selecting a first group of the one or more groups, wherein the first group has a highest ranked one of the plurality of reliability levels denoting a most reliable level of time synchronization of all of the one or more groups; and
determining the list of one or more reliable servers corresponding to the first group of one or more discover responses.

17. A system comprising:
one or more processors; and
one or more memories comprising code stored thereon that, when executed, performs a method comprising:
a first server of a first network sending discover requests to a server set of other servers of the first network, wherein each of the discover requests queries a corresponding server of the server set regarding whether said corresponding server is a time synchronization server;
receiving, by the first server, discover responses from the other servers of the server set, wherein each of the discover responses is sent by a corresponding one of the servers of the server set and wherein said each discover response includes a reliability level denoting a reliability of said corresponding one server as a time synchronization server;
determining, by the first server, a list of one or more reliable servers based, at least in part, on the reliability levels of the discover responses;
configuring a first time synchronization service of the first server to use the list of one or more reliable servers for time synchronization of a first time clock of the first server;
performing first processing by the first time synchronization service, including:
obtaining a time value for each reliable server of the list; and
determining a target time based, at least in part, on the time value for each reliable server of the list; and
setting the first time clock of the first server to the target time.

18. One or more non-transitory computer readable media comprising code stored thereon that, when executed, perform a method comprising:
a first server of a first network sending discover requests to a server set of other servers of the first network, wherein each of the discover requests queries a corresponding server of the server set regarding whether said corresponding server is a time synchronization server;
receiving, by the first server, discover responses from the other servers of the server set, wherein each of the discover responses is sent by a corresponding one of the servers of the server set and wherein said each discover response includes a reliability level denoting a reliability of said corresponding one server as a time synchronization server;
determining, by the first server, a list of one or more reliable servers based, at least in part, on the reliability levels of the discover responses;
configuring a first time synchronization service of the first server to use the list of one or more reliable servers for time synchronization of a first time clock of the first server;
performing first processing by the first time synchronization service, including:
obtaining a time value for each reliable server of the list; and
determining a target time based, at least in part, on the time value for each reliable server of the list; and
setting the first time clock of the first server to the target time.
